(19) United States
(12) Patent Application Publication
(10) Pub. No.: US 2013/0147962 A1
(43) Pub. Date: Jun. 13, 2013

(54) Wireless Camera Data Communication

(71) Applicant: MICROPOWER TECHNOLOGIES, INC., San Diego, CA (US)

(72) Inventors: Jon Siann, Rancho Santa Fe, CA (US); Michael Tinker, Carlsbad, CA (US)

(73) Assignee: MICROPOWER TECHNOLOGIES, INC., San Diego, CA (US)

(21) Appl. No.: 13/708,968

(22) Filed: Dec. 8, 2012

Related U.S. Application Data
(60) Provisional application No. 61/569,206, filed on Dec. 9, 2011.

(51) Int. Cl. H04N 7/18

(52) U.S. Cl. CPC H04N 7/181
USPC 348/159

(57) ABSTRACT

Disclosed is a communication system including a first set of wireless cameras, a first hub and a first relay device receiving first video data. Also included is a second set of wireless cameras, a second hub and a second relay device which receives (i) the first video data and (ii) a second video data. Included is a third set of wireless cameras, a third hub and a third relay device receiving (i) the first and second video data and (ii) a third video data. A monitoring device monitors the first, second and third relay devices. A video management system receives the first, second and third video data from the third relay device. If the second relay device is unable to transmit the video data at a minimum quality level, the monitoring device sends a signal directing the first relay device to send first video data via the third relay device.

### CROSS REFERENCE TO RELATED APPLICATIONS

This application claims priority benefit to U.S. Provisional Application No. 61/569,206, entitled “Wireless Camera Data Communication” filed Dec. 9, 2011, which is incorporated by reference in its entirety herein as if it was put forth in full below.

### BACKGROUND

Network camera systems can be based on Internet protocol (IP) and use Ethernet based networking technology. In some applications, network camera systems are replacing analog closed circuit television (CCTV) due to various factors, such as accessibility, ease-of-use, cabling scalability, and lower cost of deployment and operation. With the ubiquity of wireless networks such as WiFi networks (based on IEEE 802.11 standards) and the emerging WiMAX networks (based on IEEE 802.16 standards), wireless network camera systems are gaining popularity and may become the dominant platform for video surveillance applications.

In an IP surveillance environment, a network camera system can include IP cameras connected via twisted pair cabling to a network switch. Alternatively, the network connection can be achieved using wireless local area networking (LAN) technology standard. In various applications, IP cameras can include a web-server capability and remote clients or observers connected to the camera via standard TCP/IP interface standards such as FTP or HTTP. IP based network camera systems can be designed using commercial off-the-shelf (COTS) components from a diverse number of suppliers.

### SUMMARY

Disclosed herein is a wireless camera data communication system including a first set of remote wireless cameras, a first hub in communication with the first set of wireless cameras and a first relay device receiving first video data from the first hub via a connection. Also included is a second set of remote wireless cameras, a second hub in communication with the second set of wireless cameras and a second relay device which receives (i) the first video data from the first relay device and (ii) a second video data from the second hub. Furthermore included is a third set of remote wireless cameras, a third hub in communication with the third set of wireless cameras and a third relay device receiving (i) the first and second video data from the second relay device and (ii) a third video data from the third hub. A monitoring device monitors the first, second and third relay devices. A video management system receives the first, second and third video data from the third relay device. If the second relay device is unable to transmit the video data at a minimum quality level, the monitoring device sends a signal directing the first relay device to send first video data via the third relay device.

The present invention is better understood upon consideration of the detailed description below in conjunction with the accompanying drawings and claims.

### BRIEF DESCRIPTION OF DRAWINGS

FIG. 1 illustrates an example environment for a wireless camera data communication system;

FIG. 2 depicts example embodiments of a wireless camera data communication system;

FIG. 3 shows an example embodiment of several wireless cameras surveying an oil pipeline;

FIG. 4 details example embodiments of a wireless camera data communication system;

FIG. 5 is an example embodiment of a wireless camera data communication system; and

FIG. 6 shows example embodiments by flowchart of a wireless camera data communication system.

### DETAILED DESCRIPTION

The present invention provides a wireless camera data communication system comprising a first set of remote wireless cameras, a first hub in communication with the first set of wireless cameras and a first relay device receiving first video data from the first hub via a connection. Also included is a second set of remote wireless cameras, a second hub in communication with the second set of wireless cameras and a second relay device which receives (i) the first video data from the first relay device and (ii) a second video data from the second hub. Furthermore included is a third set of remote wireless cameras, a third hub in communication with the third set of wireless cameras and a third relay device receiving (i) the first and second video data from the second relay device and (ii) a third video data from the third hub. A monitoring device monitors the first, second and third relay devices. A video management system receives the first, second and third video data from the third relay device. If the second relay device is unable to transmit the video data at a minimum quality level, the monitoring device sends a signal directing the first relay device to send first video data via the third relay device.

The primary focus of the wireless camera is collecting video data. The connection and the communication between cameras, hubs and relay devices are wireless. The minimum quality level is predetermined and based on a perception of an ordinary user. In one embodiment, the first, second and third relay devices are located in a microwave relay network. The microwave backhaul is greater than 1 Gbps backhaul bandwidth capacity.

In one embodiment, the monitoring device is located remotely from the first, second and third hub and remotely from the first, second and third relay devices. In another embodiment, the monitoring device is located inside at least one of the first, second and third hubs. The wireless cameras are associated with two or more hubs, base stations, or relay devices and may be wearable, weighing less than about 50 grams.

A user may provide an input by interfacing directly with the remote wireless camera. In some embodiments, one or more wireless cameras operate using energy obtained by solar, wind, thermal or other environmentally friendly energy sources. The distance between relay stations may be greater than 5 kilometers.

The first hub, the second hub and the third hub are in communication with the first set of wireless cameras, the second set of wireless cameras and the third set of wireless cameras respectively. The video management system receives the first, the second or the third video data from any combination of the first hub, the second hub, the third hub, the first relay station, the second relay station and/or the third relay station.

Also disclosed is a method for monitoring a wireless camera data communication system, the wireless camera data communication system including a first set of remote wireless cameras, a first hub, a first relay device, a second set of remote wireless cameras, a second hub, a second relay device, a third set of remote wireless cameras, a third hub and a third relay device. The method comprises receiving a first video data from the first hub to the first relay device, receiving (i) the first video data from the first relay device to the second relay device and (ii) a second video data from the second hub to the second relay device, receiving (i) the first and second video data from the second relay device to the third relay device and (ii) a third video data from the third hub to the third relay device, and receiving the first, the second and the third video data from the third relay device to a video management system. The first, the second and the third relay devices are monitored and a signal is sent directing the first relay device to send the first video data to the third relay device when the second relay device is unable to transmit video data at a minimum quality level. The sending is routed by a video monitoring device.

The step of sending the signal is based upon at least one of the following metrics: (i) The video stream is not received, and (ii) A video frame rate, an error rate or a video quality falls below an acceptable measure as determined by the video monitoring device or a perception of an ordinary user. Video performance metrics are used (i) to determine a failure point between the first relay and the second relay, or the second relay and the third relay, or the third relay and the first relay and (ii) to determine alternate routing paths to reestablish a data path between the first relay, the second relay or the third relay with the first hub, the second hub or the third hub.

Multiple video management systems and multiple video monitoring devices are attached to multiple points between the first relay, the second relay and the third relay and the video management systems and the multiple video monitoring devices are able to communicate through a non-relayed communication link. When a failure point is detected, a best routing method is determined to ensure retention of data connections to a maximum number of the first hub, the second hub and the third hub by redirecting and relaying of the data through an alternate video management system. A bandwidth of a communication link of the system is reduced by not relaying the first video data or the second video data at all times.

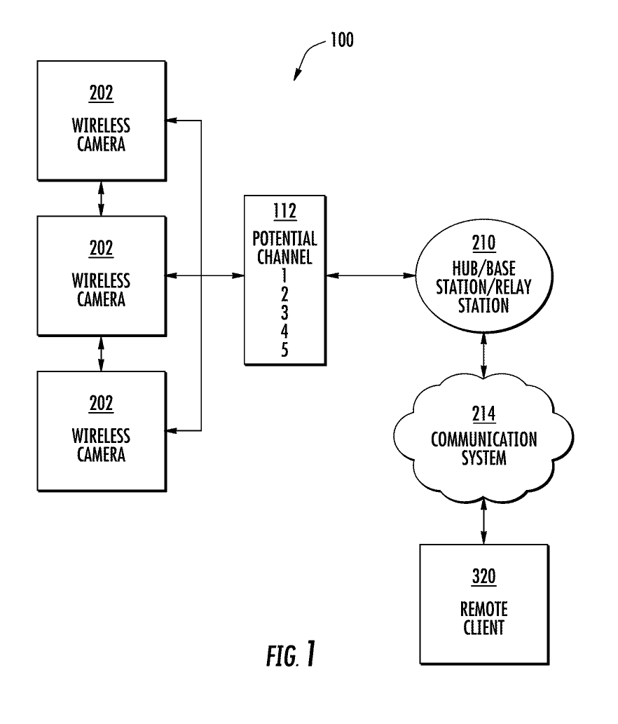

FIG. 1 illustrates an example environment for a wireless camera data communication system 100. In this example, a network camera system includes a plurality of wireless cameras 202. A plurality of wireless cameras 202 may optionally communicate with one another. The primary focus of the wireless camera is collecting video data. Wireless cameras 202 transmit data to a hub 210 via a channel within potential channels 112. Hub 210 is optionally located in a base station which is optionally part of a relay device. A relay device may include a relay station, relay system, relay server or a simple relay. A plurality of wireless cameras may also be associated with two or more hubs, base stations, or relay devices to provide redundancy in case one of the hubs, base stations, or relay devices experiences a failure. Furthermore, a plurality of wireless cameras may be associated with a plurality of hubs, base stations, or relay devices in a mesh-architecture to maximize redundancy, robustness, integrity, resiliency and low power operation.

Hub 210 is configured to receive information from the one or more wireless cameras 202 and scans one or more potential communication channels 112 for channel availability between hub 210 and wireless cameras 202. Once an available channel 112 is obtained for data transmission based on the scanning of channel availability, the available channel in potential channels 112 is associated with a specific wireless camera 202. The associating of the available channel within the potential channels 112 may include reserving the available channel for a predetermined period of time, and assigning the reserved available channel to the specific wireless cameras. In addition, during the predetermined period of time, the reserved available channel may appear to other wireless cameras 202 as unavailable for wireless communication in one embodiment, or may appear as available for wireless communication in another embodiment.

A communication system 214 connects hub 210 with the remote client 320. This communication system 214 may be a network such as a wireless network (e.g., a Bluetooth connection, a cellular network, a wireless Ethernet network, a WiFi network, or a WiMAX network), or a wired network (e.g., LAN/WAN network, or POE network), or a microwave link. Remote client 320 may be a device such as a network video recording device (NVR), video management system, mobile phone, personal digital assistance (PDA), smartphone, laptop, computer or the like.

In one embodiment, hub 210 processes the received information. In another embodiment, hub 210 may also be one or more devices such as computers receiving and processing the information as a wireless base station 210. Hence, the computers may function as base station 210 as well as remote client 320.

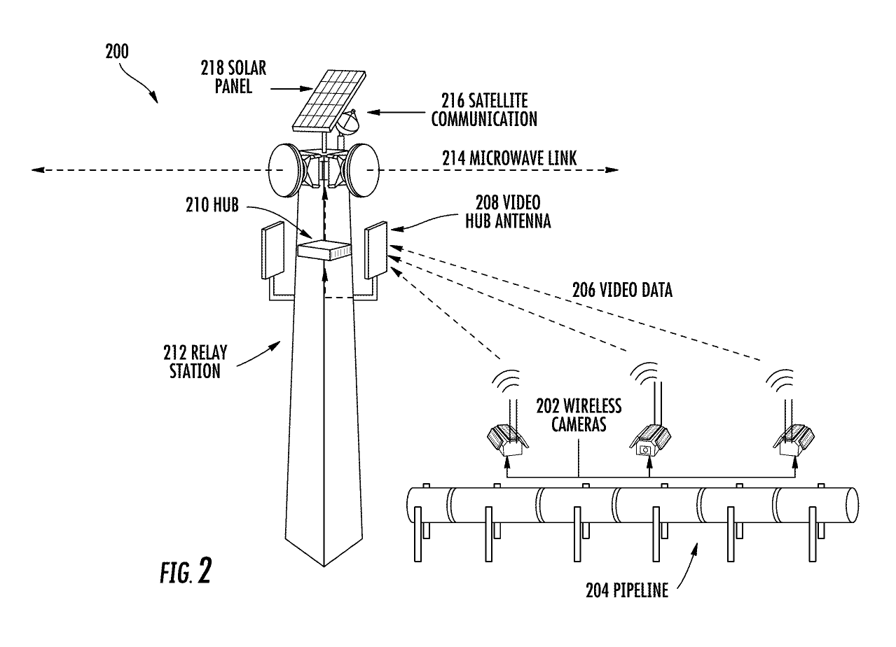

A chain of wireless cameras may be arranged in a linear sequence, such as along a pipeline, railway line, trail or otherwise organized in a linear sequence, and are enabled for a short period in sequence along the linear arrangement. The video output from the wireless cameras, when viewed sequentially, creates the illusion of a virtual flight path along the linear sequence. FIG. 2 depicts example embodiments of a wireless camera data communication system 200. Again, the primary focus of the wireless camera is collecting video data. Several wireless cameras 202 are mounted to survey a region, for example, a military zone, an oil pipeline, the perimeter of a residential or commercial building, or a country's border. Other example uses for the wireless camera data communication system include deployment in outdoor recreation areas such as skiing and snow-boarding trails, golf courses and the like. In such implementations, the wireless video cameras would be deployed and aligned in locations to obtain an optimal field of view of the trails, runs or routes. Virtual patrol or using network surveillance is more practical than using on-site patrol. In such applications, the video captured could be used for maintaining safety, security and to help manage congestion. In addition, the video obtained from such recreational area implementations can be sold to the public in the form of live feeds for remote observation, and/or in the form of edited video highlights of activities at the location.

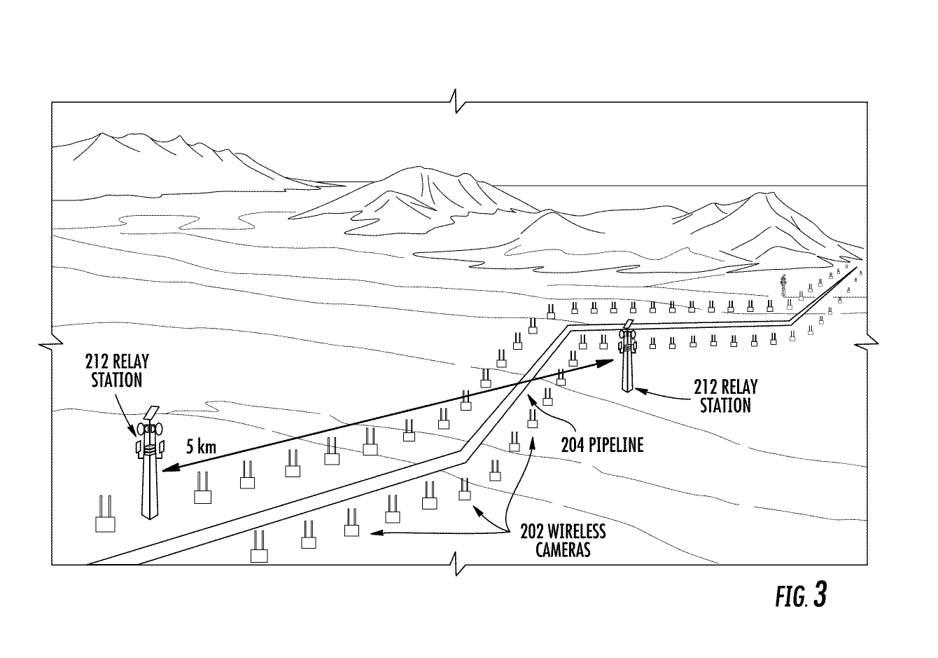

FIG. 3 shows an example embodiment of several wireless cameras surveying an oil pipeline. These wireless cameras may be permanently mounted such as on a pole or on a side of a building or other structure. In other implementations the cameras may temporarily mounted arranged in a wearable form factor such as on clothing (hat, belt or the like) and may weigh less than about 50 grams. A user may be physically located near the camera and may provide a user input by interfacing directly with the camera. For example, there may be a button located on the camera, and when the user presses the button, a signal is sent to the hub indicating that image data from that camera should be assigned a high priority. Therefore, the data transmitted by that camera is prioritized based on input from a user. The wireless cameras are associated with a hub and transmit image data over channels as described above. One or more wireless cameras may operate using energy obtained by through solar, wind, thermal or other environmentally friendly obtained energy sources enabling the relay station to function without the needs of a power cable. The connection and the communication is wireless. Elimination of the need for power cabling and power cabling support reduces deployment and maintenance costs while simultaneously reducing the risk of severance of cables due to sabotage or failure.

Referring to FIGS. 2 and 3, wireless cameras 202 are permanently mounted to survey a pipeline 204. Wireless cameras 202 collect image data and transmit the video data 206 to video hub antenna 208 which is then received and processed by hub 210. Hub 210 may be associated with one or more wireless cameras.

In this embodiment, hub 210 is housed on a relay device, relay station 212. Relay station 212 allows data to flow through without gating or switching. In further embodiments, relay station 212 may be used for data and voice communications such as Supervisory Control and Data Acquisition (SCADA) network for monitoring sensor data and valve control, corrosion monitoring via cathode protection sensors, detection of pressure, flow and leakage, Voice over Internet Protocol (VOIP) and telecommunications.

A microwave link 214 is a continuous active link which provides immediate failover for an inoperable relay station(s). Failover is an automatic switching to a redundant or standby device such as a hub, base station, another relay device or the like upon the failure or abnormal termination of the previously active relay station. Multiple levels of redundancy for automatic network repair may be provided in microwave link 214 as well as Federal Information Processing Standards (FIPS) compliant encryption. The microwave backhaul may be greater than 1 Gbps backhaul bandwidth capacity.

Each relay station 212 may be associated with one or more hubs and may include an emergency satellite communications dish 216. This is a further redundant link using satellite communications from the relay in case the microwave backhaul fails. In this case, selective video data is sent via a satellite communications network to the client 320 such as the video management system or NVR. This is used in case primary failover is unavailable. Furthermore, relay station 212 may contain an array of solar panels 218 to generate and supply electricity thus a solar powered solution for remote applications. In other embodiments, a relay station may operate using energy obtained by through solar, wind, thermal or other environmentally obtained energy sources enabling the relay station to function without the need of a power cable. Elimination of the need for power cabling and power cabling support reduces deployment and maintenance costs while simultaneously reducing the risk of severance of cables due to sabotage or failure.

In one embodiment, client 320 may be a network video recording device (NVR) located in the relay station or located remotely. A NVR is a software program that records video in a digital format to a storage device. With a NVR, video input is encoded and processed at the camera then streamed to the NVR for storage or remote viewing over a network such as cloud computing or a proprietary network or the like.

This network described in FIGS. 2 and 3 may support thousands of cameras deployed in a linear arrangement. The total span of each wireless camera is approximately 5 km to a relay station thus scalable to surveying hundreds of kilometers. Distances between relay stations may be greater than 5 kilometers. In addition, wireless cameras 202 may optionally include solar panels supporting rechargeable batteries to reduce or remove other power source needs. Furthermore, the arrangement of cameras may be in a non-linear layout.

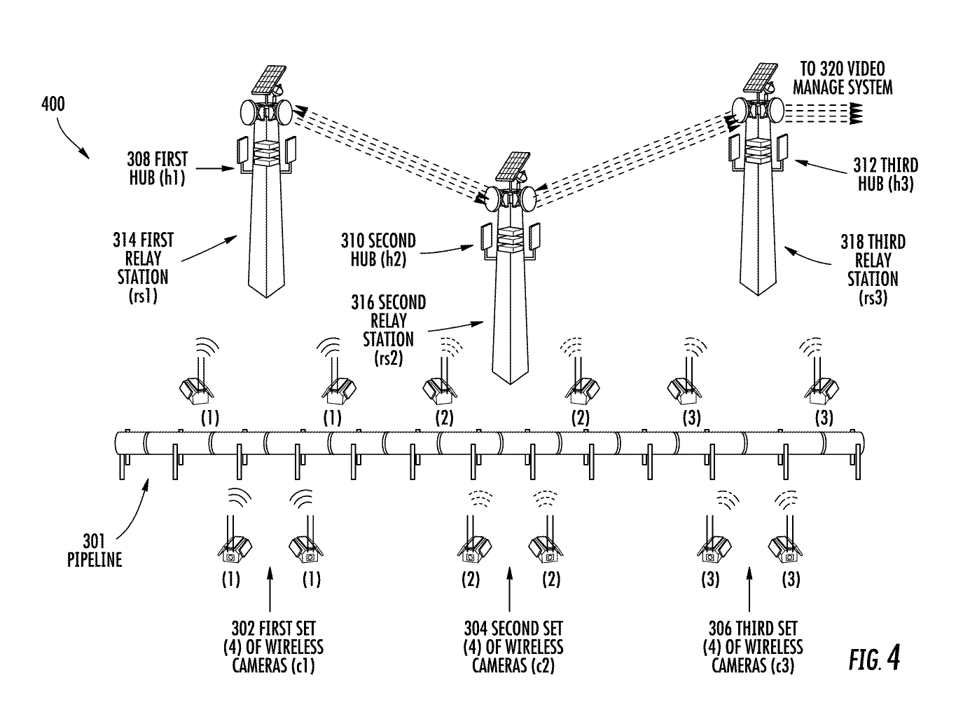

FIG. 4 details example embodiments of a wireless camera data communication system 400. This example is for illustrative purposes and does not limit the scope of the invention. In this embodiment, several wireless cameras are used to survey an oil pipeline 301 for activities such as terrorist attacks, sabotage or spills. A first set of wireless cameras (c1) 302 is shown as four cameras. C1 302 transmits a first video data to a first hub (h1) 308 which is in wireless communication with the multiple wireless cameras or c1 302. A first relay device, which is a relay station (rs1) 314, receives the first video data from h1 308 via a wired connection. Next in the system is a second set of wireless cameras (c2) 304 which transmits a second video data to a second hub (h2) 310 which is in wireless communication with the second set of wireless cameras or c2 304. A second relay device, which is a relay station (rs2) 316, receives the first video data from rs1 314 and the second video data from h2 310. Furthermore, a third set of wireless cameras (c3) 306 transmits a third video data to a third hub (h3) 312 which is in wireless communication with the third set of wireless cameras (c3) 306. A third relay device (rs3) 318 receives the first and second video data from rs2 316 and the third video data from h3 312. The hubs and relays may also optionally communicate with other hubs or other relays in the network. The first hub, the second hub and the third hub are in communication with the first set of wireless cameras, the second set of wireless cameras and the third set of wireless cameras respectively.

A monitoring device monitors the first, second and third relay devices, rs1 314, rs2 316 and rs3 318 and is located remotely from the first, second and third hubs as well as remotely from the first, second and third relay devices. Optionally, the monitoring device may be located inside at least one of the first, second or third hubs, for example first hub h1 308. The first, second and third relay devices, rs1 314, rs2 316 and rs3 318, are located in a microwave relay network. A video management system 320 operates as the client and receives the first, second and third video data. Video management system 320 is a centralized administration with real-time access to live images to pinpoint incidences and export detailed digital video evidence. The data can also be stored locally or remotely.

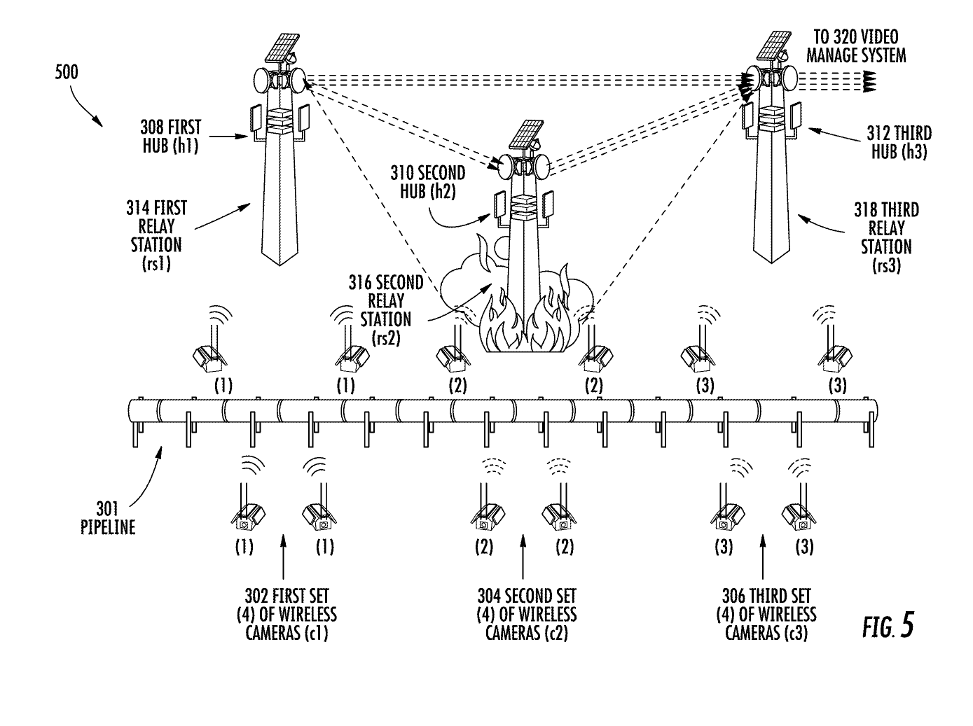

FIG. 5 is an example embodiment of a wireless camera data communication system. If, for example, the second relay device rs2 316 becomes inoperative due to a bomb, fire or the like, and is therefore unable to transmit the second video data at a minimum quality level, or at all, in one embodiment, the second video data may be lost and the first video data from rs1 314 cannot be received. In another embodiment, the monitoring device may send a signal directing the first relay device rs1 314 to send the first video data via the third relay device rs3 318. The step of sending the signal may be based upon (i) the video stream is not received and/or (ii) a video frame rate, an error rate or a video quality falls below an acceptable measure as determined by the video monitoring device or a perception of an ordinary user. Video performance metrics are used (i) to determine a failure point between the first relay and the second relay, or the second relay and the third relay, or the third relay and the first relay and (ii) to determine alternate routing paths to reestablish a data path between the first relay, the second relay or the third relay with the first hub, the second hub or the third hub.

A video management system 320 receives the first video data from the third relay device rs3 318. In this way, the first video data will not be lost and sent along to rs3 318 but the second video data that cannot be sent due to the second relay device rs2 316 being inoperative from second hub h2 310 is lost. In a further embodiment, wireless cameras c2 are in communication with third hub h3 312, and data from this set of wireless cameras c2 304 is sent to third hub h3 312, so that no data is lost due to the inoperability of relay device rs2 316. The video management system receives the first, the second or the third video data from any combination of the first hub, the second hub, the third hub, the first relay station, the second relay station and/or the third relay station.

In one embodiment, multiple video management systems and multiple video monitoring devices are attached to multiple points between the first relay, the second relay and the third relay and the video management systems and the multiple video monitoring devices are able to communicate through a non-relayed communication link. When a failure point is detected, a best routing method is determined to ensure retention of data connections to a maximum number of the first hub, the second hub and the third hub by redirecting and relaying of the data through an alternate video management system. A bandwidth of a communication link of the system is reduced by not relaying the first video data or the second video data at all times.

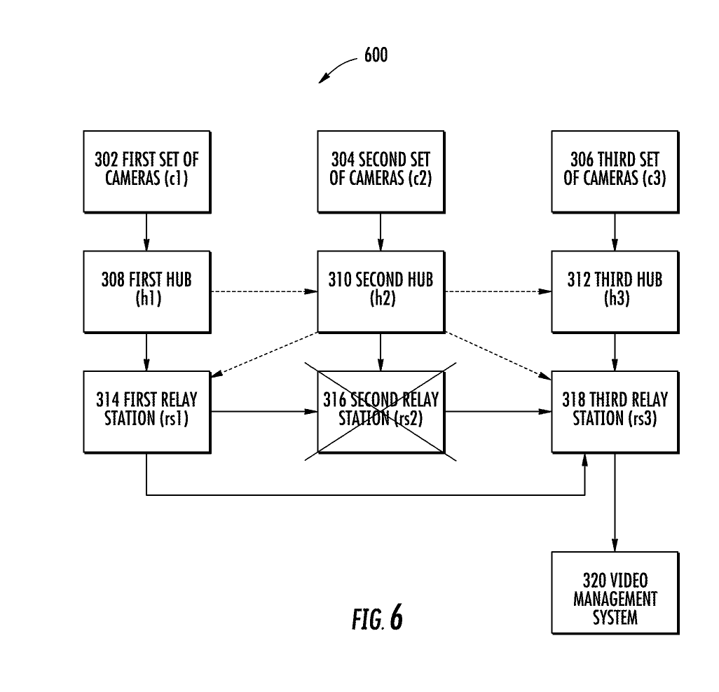

FIG. 6 shows example embodiments by flowchart of a wireless camera data communication system detailed in FIGS. 4 and 5. Multiple levels of redundancy enable the video data to be sent uninterrupted. In another embodiment, if rs2 316 is unable to transmit video data at a minimum quality level, the monitoring device may send a signal directing h2 310 to send the second video data to rs1 314. Then, rs1 314 sends the first video data and the second video data via rs3 318. In this way, the second video data is not lost and all video data is received by the video management system 320 via the microwave relay network.

The minimum quality level is predetermined and based on a perception of an ordinary user. Many metrics factor into the minimum quality level of the video or camera data such as the frame rate of the data, the resolution of the data, the bit rate of the data and the frame modulation on the data. A user may determine an acceptable minimum quality level based on these or other factors.

In a further embodiment, if rs2 316 is unable to transmit video data at a minimum quality level, the monitoring device may send a signal directing rs1 314 to send the first video data to rs3 318, and h2 310 to send the second video data to rs3 318, and rs3 318 to send the first, second and third video via rs3 318.

In some implementations, the hub is mounted on the relay station. If the relay station becomes inoperative due to a catastrophic event such as a fire or bomb thus deeming the attached hub also inoperative, the associated wireless cameras may be instructed to transmit their data to a different hub and/or relay station. In this situation, the video data from a camera normally associated with such a destroyed hub may be redirected at the microwave link level. For example, monitoring of data on the microwave link by a device located away from the destroyed relay station/hub would show the data from the destroyed camera was no longer being sent. Redirection would then take place to send that camera's data via another hub and relay. This is particularly useful when the original/usual monitoring device is also destroyed because it's located on the same relay station.

Because the hubs and relay devices are in communication with one another, the communication paths may be varied to provide redundancy. Video management system 320 may optionally receive first, second or third video data from h1, h2, h3, rs1, rs2 or rs3, or any combination of h1, h2, h3, rs1, rs2 or rs3. In another embodiment, if two or more relay stations are inoperative and thus cannot transmit their video data, the video data is routed to the remaining relays that are operative.

In a specific example, the wireless cameras are temporarily mounted arranged in a wearable form factor such as a hat of a police officer. Five different police officers form the first set of wireless cameras which is in communication with a first hub located in the trunk of one of the officer's cars, or a first car. The first relay device is located approximately 1 mile from a crime scene. A second group of five different police officers with wireless cameras located on their hats form the second set of wireless cameras which is in communication with a second hub located in the trunk of a different officer's car, or a second car. The second relay device associated with the second hub and second set of wireless cameras is located approximately 0.25 miles from the crime scene. When the first and second set of police officers are at the crime scene, the first and second video data is recorded and transmitted to the respective first and second hubs then to the respective first and second relay devices and finally to the video management system via a microwave network.

At this particular crime scene, the officer's car with the first hub, or the first car, is smashed rendering the first hub inoperative. At this point, the monitoring device sends a signal to the first set of cameras to transmit the first video data to the second hub. The second hub is directed to transmit the first and second video data to the second relay. In this way, all video data is received at the video management system.

In another specific example, a first set of wireless cameras are mounted around the perimeter of a commercial office building. Due to the size of the building, there is also a second, third and fourth set of wireless cameras. The data path is through the respective first, second, third and fourth hubs and relay devices. Unfortunately, vandalism occurs and the third set of wireless cameras is damaged and unable to collect data. The third hub detects the inoperative set of cameras and the monitoring system directs the second and fourth set of wireless cameras to collect the video data in the area where the third set of wireless cameras cannot. Once the video data is collected it is transmitted via its respective data path.

The present invention uses wireless cameras to transmit video data for viewing or recording away from the cameras. Video data is significantly different from other data because of the size of the data packets are much larger with a higher level of content. Transmitting video data real-time may be challenging because the video data is constant and asynchronous, and intolerant to latency. The configurations set forth in the FIGS. 1-6 provide for reliable transmission of video data from wireless remote cameras.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the invention. Thus, it is intended that the present subject matter covers such modifications and variations.

1. A wireless camera data communication system comprising:
a first set of remote wireless cameras;
a first hub in wireless communication with the first set of wireless cameras;
a first relay device receiving a first video data from the first hub via a connection;
a second set of remote wireless cameras;
a second hub in communication with the second set of wireless cameras;
a second relay device receiving (i) the first video data from the first relay device and (ii) a second video data from the second hub;
a third set of remote wireless cameras;
a third hub in communication with the third set of wireless cameras;
a third relay device receiving (i) the first and second video data from the second relay device and (ii) a third video data from the third hub;
a monitoring device monitoring the first, second and third relay devices; and
a video management system for receiving the first, second and third video data from the third relay device;
wherein, when the second relay device is unable to transmit the video data at a minimum quality level, the monitoring device sends a signal directing the first relay device to send the first video data via the third relay device.

2. The wireless camera data communication system of claim 1, wherein the minimum quality level is predetermined and based on a perception of an ordinary user.

3. The wireless camera data communication system of claim 1, wherein the primary focus of the wireless camera is collecting video data.

4. The wireless camera data communication system of claim 1, wherein the first, second and third relay devices are located in a microwave relay network.

5. The wireless camera data communication system of claim 1, wherein the monitoring device is located remotely from the first, second and third hub and remotely from the first, second and third relay devices.

6. The wireless camera data communication system of claim 1, wherein the monitoring device is located inside at least one of the first, second and third hubs.

7. The wireless camera data communication system of claim 1, wherein the wireless cameras are associated with two or more hubs, base stations, or relay devices.

8. The wireless camera data communication system of claim 1, wherein the remote wireless cameras are wearable and weigh less than about 50 grams.

9. The wireless camera data communication system of claim 1, wherein a user provides an input by interfacing directly with the remote wireless camera.

10. The wireless camera data communication system of claim 1, wherein one or more wireless cameras operate using energy obtained by solar, wind, thermal or other environmentally friendly energy sources.

11. The wireless camera data communication system of claim 1, wherein a microwave backhaul is greater than 1 Gbps backhaul bandwidth capacity.

12. The wireless camera data communication system of claim 1, wherein the distance between relay stations is greater than 5 kilometers.

13. The wireless camera data communication system of claim 1, wherein the video management system receives the first, the second or the third video data from any combination of the first hub, the second hub, the third hub, the first relay station, the second relay station and/or the third relay station.

14. The wireless camera data communication system of claim 1, wherein the connection and the communication is wireless.

15. The wireless camera data communication system of claim 1, wherein a bandwidth of a communication link of the system is reduced by not relaying the first video data or the second video data at all times.

16. A method for monitoring a wireless camera data communication system, the wireless camera data communication system including a first set of remote wireless cameras, a first hub, a first relay device, a second set of remote wireless cameras, a second hub, a second relay device, a third set of remote wireless cameras, a third hub and a third relay device, the method comprising:
receiving a first video data from the first hub to the first relay device;
receiving (i) the first video data from the first relay device to the second relay device and (ii) a second video data from the second hub to the second relay device;
receiving (i) the first and second video data from the second relay device to the third relay device and (ii) a third video data from the third hub to the third relay device;
receiving the first, the second and the third video data from the third relay device to a video management system;
monitoring the first, the second and the third relay devices; and
sending a signal directing the first relay device to send the first video data to the third relay device when the second relay device is unable to transmit video data at a minimum quality level;
wherein the sending is routed by a video monitoring device.

17. The method of claim 16, wherein the minimum quality level is predetermined and based on a perception of an ordinary user.

18. The method of claim 16, wherein the primary focus of the wireless camera is collecting video data.

19. The method of claim 16, wherein a user provides an input by interfacing directly with the remote wireless camera.

20. The method of claim 16, wherein the first hub, the second hub and the third hub are in communication with the first set of wireless cameras, the second set of wireless cameras and the third set of wireless cameras respectively.

21. The method of claim 16, wherein the connection and the communication is wireless.

22. The method of claim 16, wherein a decision on the signal directing is based upon at least one of the following metrics:
(i) The video stream is not received; and
(ii) A video frame rate, an error rate or a video quality falls below an acceptable measure as determined by the video monitoring device or a perception of an ordinary user.

23. The method of claim 16, wherein video performance metrics are used (i) to determine a failure point between the first relay and the second relay, or the second relay and the third relay, or the third relay and the first relay and (ii) to determine alternate routing paths to reestablish a data path between the first relay, the second relay or the third relay with the first hub, the second hub or the third hub.

24. The method of claim 16,
wherein multiple video management systems and multiple video monitoring devices are attached to multiple points between the first relay, the second relay and the third relay and the video management systems and the multiple video monitoring devices are able to communicate through a non-relayed communication link; and
wherein, when a failure point is detected, a best routing method is determined to ensure retention of data connections to a maximum number of the first hub, the second hub and the third hub by redirecting and relaying of the data through an alternate video management system.
